(19) United States
(12) Patent Application Publication
(10) Pub. No.: US 2018/0219409 A1
(43) Pub. Date: Aug. 2, 2018

(54) Adaptive Charging Methods, Apparatus, and Systems

(71) Applicant: Ruxiang Jin, Duluth, GA (US)

(72) Inventor: Ruxiang Jin, Duluth, GA (US)

(73) Assignee: Ruxiang Jin, Duluth, GA (US)

(21) Appl. No.: 15/650,859

(22) Filed: Jul. 15, 2017

Related U.S. Application Data
(60) Provisional application No. 62/451,820, filed on Jan. 30, 2017.

(51) Int. Cl. H02J 7/35; H02J 7/00

(52) U.S. Cl. CPC H02J 7/355; H02J 7/007

(57) ABSTRACT

Exemplary embodiments of adaptive charging methods, apparatus and systems can include charging a device attachment comprising a magnetic inner case and a detachable power module via an energy source capable of generating light beams with spectra matching the sensitive spectral range of a photovoltaic receiver of the attachment. The energy source can comprise a combination of light sources to adapt to a variety of power modules comprising different combinations of batteries and photovoltaic receivers, and the power module of the device attachment can comprise several different photovoltaic receivers to adapt to a variety of light sources.

### CROSS-REFERENCE TO RELATED APPLICATIONS

This application claims the benefit of the date of provisional U.S. patent application No. 62/451,820 (Jan. 30, 2017).

### STATEMENT REGARDING FEDERALLY SPONSORED RESEARCH OR DEVELOPMENT (IF APPLICABLE)

The invention was NOT made by an agency of the United States Government or under a contract with an agency of the United States Government.

### REFERENCE TO SEQUENCE LISTING, A TABLE, OR A COMPUTER PROGRAM LISTING

Not applicable.

### COMPACT DISC APPENDIX (IF APPLICABLE)

Not applicable.

### BACKGROUND

The present invention relates to adaptively charging devices or device attachments. In particular, the present invention relates to methods, apparatus and systems for equipping various devices with adaptive charging capabilities, and for charging the devices or device attachments.

As the number of mobile- and active Internet-of-Things (IoT) devices increase rapidly, charging these devices is becoming a major challenge. For example, the most common method of charging mobile devices including cellular phones is by plugging them into electrical power outlets. However, this conventional method of charging can have many inconveniences because of the limited length of the charging wires or the inconvenient locations of grid power outlets. In many cases a power outlet is not even available. The use of a phone is often limited to a small area near the power outlet when the phone is being charged by connecting a wire to the power outlet.

In situations when a power outlet is not conveniently available, the most commonly used method of charging a mobile device such as a cellular phone is by using a mobile charger and a charging wire. However, this method also has limitations. For example, in many cases it is inconvenient to carry a charger and a wire without carrying a bag to hold them, and when charging a phone the use of the phone is tied to the wire and the charger. When a person is on the move while charging a phone, it can be quite clumsy to hold a phone, a wire and a charger with both hands.

Charging a large number of IoT devices such as video cameras or sensors spread over diverse geographical locations can become a major challenge. For example, in many places the grid power is unavailable or unstable, thereby affecting operation of many IoT devices unless supplemental power sources other than the conventional grid power can be utilized.

Although most mobile devices consume much less energy than a typical home appliance, the huge number of mobile- and IoT devices can become a non-negligible source of power consumption. Furthermore, many devices are located in areas that are not easily accessible by the existing power grid. Therefore in many cases it is preferable to use off-grid energy to power these devices.

Various wireless charging methods are emerging as new charging approaches with the purpose of eliminating the inconvenient charging wires discussed above. However, most of the wireless-charging methods are based on near-field electromagnetic resonance technology, and currently the effective distance between a wireless energy source and a device to be charged is typically limited to a few centimeters. Another problem is that the electromagnetic resonance technology or other wireless charging technologies and protocols from different manufacturers are often incompatible, making, them difficult to implement in public places. The problems discussed above are limiting the adoption of existing wireless charging methods.

### SUMMARY

An exemplary embodiment of a charging method can include the steps of bestowing optical chargeability onto an electrically chargeable object by affixing an attachment comprising a photovoltaic receiver (PVR) onto the object, positioning the object with the attachment in a charging area, generating light beams from an energy source with substantial intensity within the charging area and with spectrum substantially matching the PVR spectrum, delivering energy from the energy source to the PVR via light beams, and charging the object with the attachment by converting light-beam energy to electrical energy using the PVR of the attachment.

An exemplary embodiment of a device case or attachment can comprise a magnetic inner case or attachment including permanent magnets or magnetic materials and electrical contacts with one end of the contacts connectable to a charging port of a device, and a power module attachable to the inner device case via magnetic force, with the power module including at least one power source, electrical contacts positioned to match and engage the contacts of the inner case or attachment, and magnets or magnetic materials positioned to attach the power module to the inner case using magnetic force.

An exemplary embodiment of a wireless charging system can comprise a device attachment or device case comprising at least one PVR and at least one energy storage element, and a charging source comprising at least one light source having a substantial portion of its spectrum overlapping the spectral sensitivity range of the PVR, and at least one optical component assembly.

### BRIEF DESCRIPTION OF THE OF THE DRAWINGS

FIG. 1 is a block-diagram representation of the adaptive charging method of the present invention.

FIG. 2 is an illustrative embodiment of a device case or device attachment of the present invention.

FIG. 3A is an illustrative embodiment of the power module of a device case or device attachment with a foldable PVR.

FIG. 3B is an illustrative embodiment of the power module of a device case or device attachment with a foldable PVR in folded- and open positions.

FIG. 4 is an embodiment of the wireless charging system of the present invention.

FIG. 5 is another embodiment of the wireless charging system of the present invention.

FIG. 6 is another embodiment of the wireless charging system of the present invention.

### DETAILED DESCRIPTION OF THE INVENTION

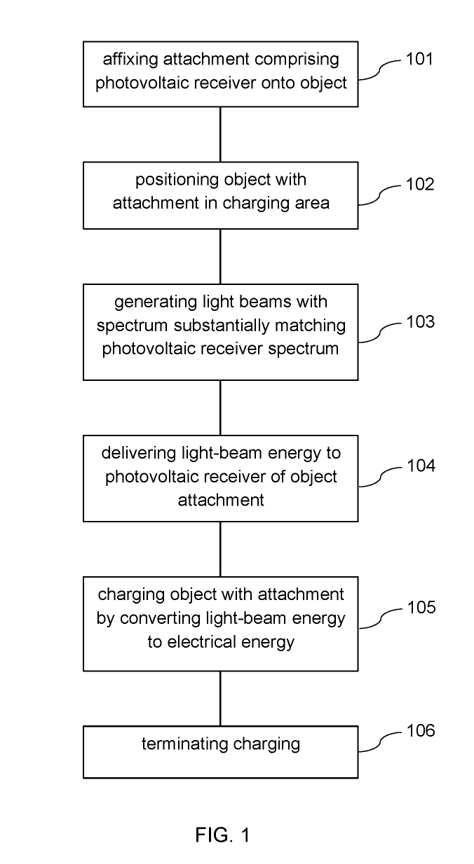

A majority of existing chargeable devices, including mobile phones and IoT devices, are not adapted to optical charging methods. FIG. 1 shows, by way of example, an embodiment of the adaptive charging method of the present invention making the devices optically chargeable. At block 101, the optical charging capability is bestowed upon an object without suitable built-in optical charging capabilities by affixing an attachment comprising a PVR onto the object and connecting the PVR to a charging port of the object. For example, it is customary to attach a protective case to a device such as a mobile phone, so in accordance with block 101 the protective case may comprise a PVR, making the mobile phone optically chargeable. At block 102, the now optically chargeable object with the PVR attachment is placed in a charging area, and at block 103 light beams from an energy source is generated, with the light-beam spectrum substantially matching the PVR spectrum for high efficiency optical- to electrical energy conversion. Energy from the energy source is delivered to the PVR inside the charging area via light beams in accordance with block 104, and the object with the attachment is charged by converting the light-beam energy to electrical energy using the PVR in accordance with block 105. The charging area is typically a pre-defined area reachable by the light beams with certain minimum intensity for effective charging. To terminate charging, the light beams can be dimmed or switched off, or the object being charged can be removed from the charging area, in accordance with block 106. The object to be charged in FIG. 1 can be any chargeable device or device attachment.

The variations of the illustrative embodiment discussed above can be applicable even for devices with a built-in PVR. For example, when the built-in PVR of an object is not a solar cell, the method can enable charging the device under sunlight when no other means of charging is available. Another example of using variations of the embodiment is that even when the built-in PVR of the object is a solar cell, a higher charging speed can be achieved by attaching a higher efficiency- or larger area PVR to the object for charging under sunlight. In general, when the built-in PVR spectrum does not match the energy-source spectrum, the charging method of the present invention can be used to adapt the device to the energy source by matching the attachment spectrum to the energy-source spectrum.

In some cases, the device attachment can comprise a plurality of modules, including a power module comprising a PVR and a battery. In such cases the embodiment of FIG. 1 can be modified to include the steps of detaching the power module from the device attachment, positioning- and charging the power module instead of the device with the attachment, and re-attaching the power module to the device attachment to charge the device.

In other cases, the relative positions between an energy source and a device attachment or a power module of the attachment can be changing in real time. In such cases the embodiment of FIG. 1 can be modified to include the steps of initiating a charging request, locating and tracking the device attachment or the power module in real time, and adjusting- and delivering optical energy to the PVR of the attachment or the power module.

The initiation and termination of charging can be accomplished by switching on- and switching off the energy source, by placing- and removing the PVR from the charging area, or by adjusting the intensity or spectral composition of the light beams. Adjusting the light-beam intensity also enables adaptation to various charging-speed requirements.

The block diagram of FIG. 1 is only an exemplary embodiment of the adaptive charging method disclosed herein, and does not exclude other embodiments within the scope of the present invention. For example, the step sequence can be varied from that of FIG. 1, or additional steps can be added to achieve particular functionalities. It is understood that these modifications and variations to the embodiments described herein fall within the scope of the invention as defined in the following claims.

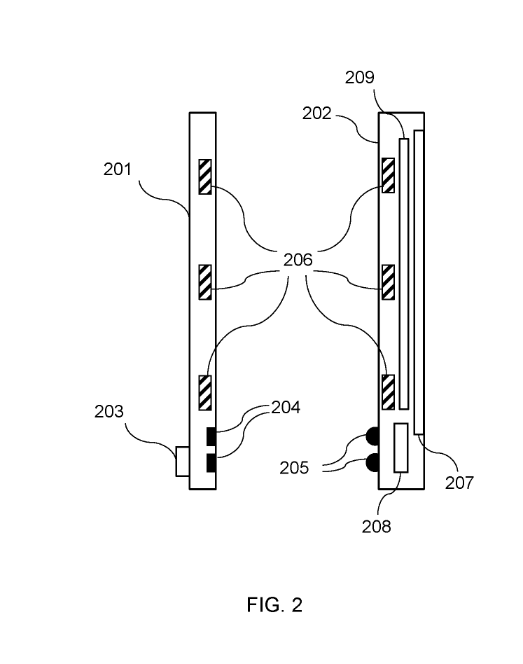

FIG. 2 is a schematic cross-sectional representation of a device case or device attachment comprising a magnetic inner case or inner attachment 201 and a power module 202 attachable to the inner case 201 via magnetic force. The inner case 201 can be connected to a chargeable device through an electrical connector 203 mating the electrical connector of a charging port of the device. The inner case 201 is also electrically connectable to the power module 202 through a plurality of electrical contacts 204. The opposite ends of the inner case contacts 204 are electrically connected to the charging-port connector 203 either directly or through certain electrical circuits comprising electronic components such as chips, resistors, inductors, capacitors, voltage converters, etc. The electrical contacts 204 of the inner case 201 and the electrical contacts 205 of the power module 202 will engage when the power module 202 is attached to the inner case 201, resulting in electrical circuit connection between the inner case and the power module. The contacts 204 or 205 are preferably Pogo-pin type contacts with minimum impedance, and are preferably made with highly conductive materials such as copper or gold-coated copper to sustain a substantial electrical current without causing power loss or over-heating. In FIG. 2 the contacts 204 of the inner case 201 can be fixed-type contacts while the contacts 205 of the power module 202 can be Pogo-pin type contacts, but the choice is only exemplary, and the types of contacts of the inner case 201 and the power module 202 can be reversed. It is also understood that many other types of contacts or connectors can be used to achieve electrical connection between the inner case 201 and the power module 202 without departing from the scope of the present invention.

Both the inner case 201 and the power module 202 in FIG. 2 comprise a plurality of permanent magnets or magnetic materials 206 located at matching positions. The polarity of the magnets of the inner case 201 is opposite to that of the power module 202, thereby generating a strong attractive magnetic force between the inner case 201 and the power module 202 when they are brought close to one another. The dimensions and the placement of the magnets should preferably be such that the attractive magnetic force is strong enough to hold the inner case 201 and the power module 202 tightly together under normal circumstances, yet not too strong to prevent detaching the power module 202 from the inner case 201 by using moderate force, such as by using the force of both hands. While the shapes- and placement of the magnets in the inner case 201 and the power module 202 can be different from one another, they should preferably be designed to impact some lateral confinement between the inner case 201 and the power module 202. Additional mechanical position confinement primarily in the lateral plane perpendicular to the direction of the main magnetic attraction can be used if needed. It is also possible to use a combination of magnets and magnetic materials to achieve the magnetic attraction and confinement discussed above. For devices with built-in components such as magnetometers that are sensitive to magnetic fields, the shapes- and positions of the magnets 206 should be carefully chosen to minimize the magnetic interference effects.

The power module 202 in FIG. 2 comprises a PVR 207, a charge controller 208, and an energy-storage element 209. The PVR 207 receives optical energy, and converts it to electrical energy to charge a battery as the energy-storage element 209. The charging process is regulated and controlled by the charge controller 208 to maintain a substantial charging speed while avoiding potential hazards during the charging process, such as over-current, overheating, short-circuiting, and so forth. The detachability of the power module 202 from the inner case 201 enables the separation of the charging functionalities from the protective functionalities of a device case, and enhances the overall adaptive capabilities of the case by allowing the attachment of different types of power modules to adapt to variations of optical power, spectrum, battery capacity, charging speed; environment, etc.

Most types of PVRs comprise semiconductor materials such as silicon, germanium, gallium arsenide (GaAs), aluminum gallium arsenide (AlGaAs), indium phosphide, and so forth, in the crystalline- or amorphous form. For example, one type of PVR is a solar cell comprising crystalline-silicon material. A silicon solar cell optimized for moderate conversion efficiency of around 20% under sunlight can also work as a moderate efficiency PVR for indoor light sources because most lamps are designed to have a spectrum similar to the sunlight spectrum in the visible spectral range. A multi-junction solar cell made with GaAs/AlGaAs or other materials can reach efficiencies in the 40-50% range under intense- or concentrated sunlight.

It should be understood that although a power module 202 comprising one PVR and one battery is shown if FIG. 2, other types magnetically attachable power modules can be used interchangeably as long as the contacts 205 of the power module matches the contacts 204 of the inner case. For example, the power source of a power module may comprise an energy-storage element 209 only with no PVR. The energy-storage element 209 can be a lithium battery, a super capacitor, and so forth, or combinations thereof. Conversely, the power source of a power module may comprise a PVR 207 only with no energy-storage element. The PVR 207 can comprise a solar cell or a solar-cell array, or a narrow-band receiver tailored to certain laser wavelengths, or a combination of a plurality of PVRs, each with different material compositions and spectral characteristics.

The magnetic inner case or attachment 201 can also include a PVR such as a solar cell, a solar-cell array, a narrow band receiver tailored to certain laser wavelengths, or a combination of a plurality of PVRs with different material compositions and spectral characteristics. The inner case can also include an energy-storage element such as a battery or a super capacitor, or other types of energy storage elements or combinations thereof. The magnetic inner case or attachment 201 can also include both a PVR and an energy-storage element discussed above. The energy exchange between the inner case 201 and the power module 202 can also be achieved by wireless means using electromagnetic resonance or other mechanisms without needing the contacts 204 and 205, or by a combination of wired- and wireless means. All these variations are within the scope of the present invention.

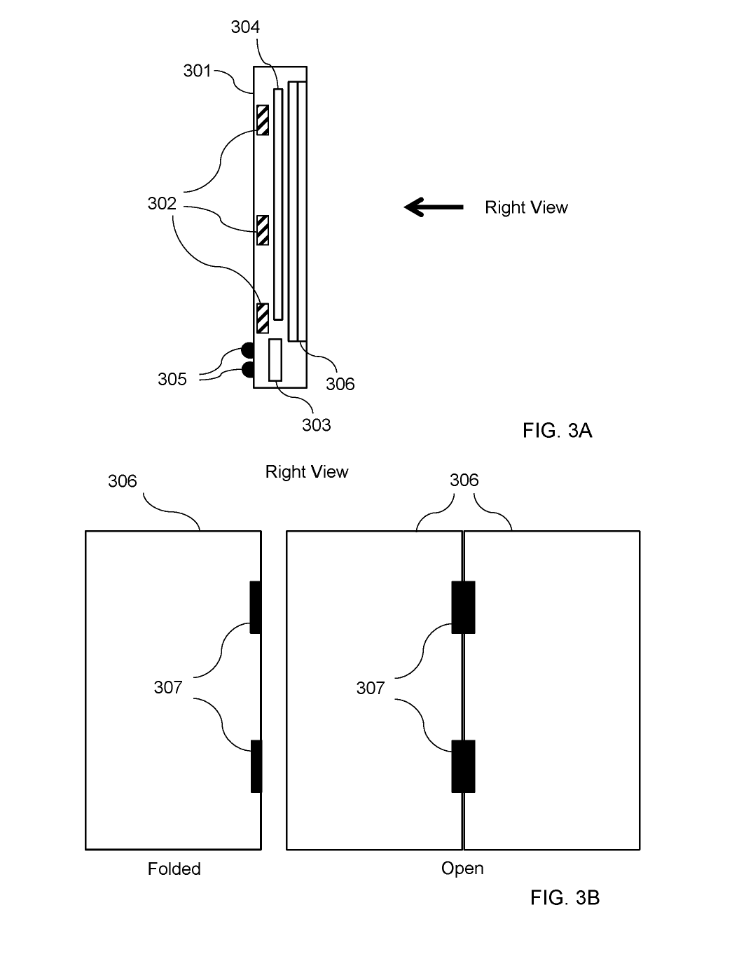

In some charging circumstances, such as charging by sunlight, the charging speed can be improved by increasing the active area (i.e. the area capable of optical-to electrical energy conversion) of the PVR 207. However, for many types of device attachments including cell-phone cases, the active area of the PVR 207 can be limited by the surface area of the device, thereby limiting the charging speed. To overcome this limitation, FIG. 3 illustrates an embodiment of the power module of a device case or device attachment with a foldable PVR. FIG. 3A is the cross-sectional illustration of a power module 301 comprising magnets 302, a charge controller 303, a battery 304, electrical contacts 305, and a foldable PVR 306. The power module 301 is mostly the same as the power module 202 of FIG. 2 except that the PVR 306 now comprises two PVR plates stacked on top of each other in a folded position. FIG. 3B shows the right view of the PVR 306 in both the folded- and open positions. The folding and unfolding can be achieved by attaching the plates of the PVR 306 to a set of hinges 307. FIG. 3B shows that the active area of the PVR 306 can be doubled in the open- or unfolded position, thereby doubling the charging speed. As the thickness of each PVR plate can be made very thin (typically of the order of one millimeter), more than two PVR plates can be folded into the device attachment to achieve even higher charging speeds when unfolded, without substantially increasing the overall thickness of the device attachment. Many other embodiments of folding mechanisms, such as using magnetic attraction instead of hinges, are possible without departing from the scope of the present invention.

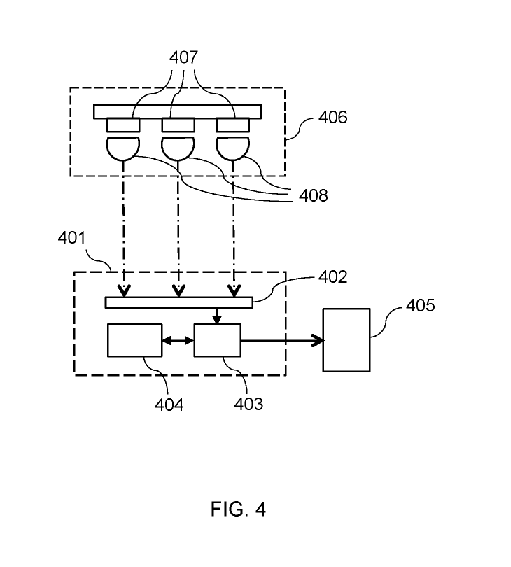

FIG. 4 is an embodiment of the wireless charging system of the present invention. A device attachment 401, such as the attachment described in FIG. 2, comprises a PVR 402, a charge controller 403, and an energy-storage element 404. The arrows in FIG. 4 represent the energy-flow directions. A device 405 can be charged by connecting the attachment 401 to its charging port. A charging light source 406 comprising a light-emitting diode (LED) array 407 and an optical component array 408 directs a substantial portion of the light-beam energy represented by dot-dashed arrows onto the PVR 402. A substantial portion of the LED-array 407 spectrum should overlap the receiving spectrum of the PVR 402, so that a substantial portion of the light-beam energy reaching the PVR 402 is available for optical- to electrical energy conversion.

A portion of the received optical energy is converted to electrical energy by the PVR 402 to charge the energy-storage battery 404. Inside the device attachment 401, the charging process is regulated and controlled by the charge controller 403 to avoid potential hazards during charging, such as over current, overheating, short-circuiting, and so forth. The charge controller 403 also regulates and controls the discharging of the battery 404 when charging the device 405.

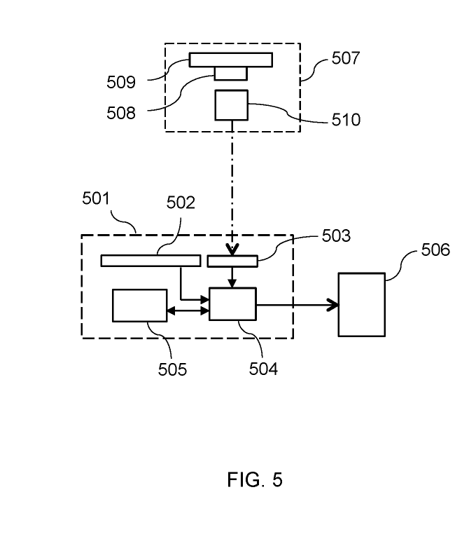

FIG. 5 is another exemplary embodiment of the wireless charging system of the present invention. The arrows in FIG. 5 represent the energy-flow directions. A device attachment 501 comprises two PVRs 502 and 503, a charge controller 504, and an energy-storage battery 505. The first PVR 502 can be a solar cell for receiving broadband solar energy under sunlight, and the second PVR 503 can be a high efficiency narrow-band receiver tailored to receiving certain laser emission. A device 506 can be charged by connecting the attachment 501 to its charging port. A charging source 507 comprising a laser diode (LD) light source 508 mounted on a heat sink 509 and a beam expander 510 directing a substantial portion of the laser beam represented by the dot-dashed arrow onto the narrow-band PVR 503. The laser spectrum is within the receiving spectral range of the PVR 503 so that a substantial portion of the light-beam energy is available for optical- to electrical energy conversion. The beam expander can also function as a collimator, thereby increasing the distance between the charging source 507 and the device attachment 501 being charged. Other types of lasers, such as chemical lasers, fiber laser, gas lasers, and so forth, or combinations thereof, can be used in variations of the embodiments discussed above, without departing from the scope of the present invention.

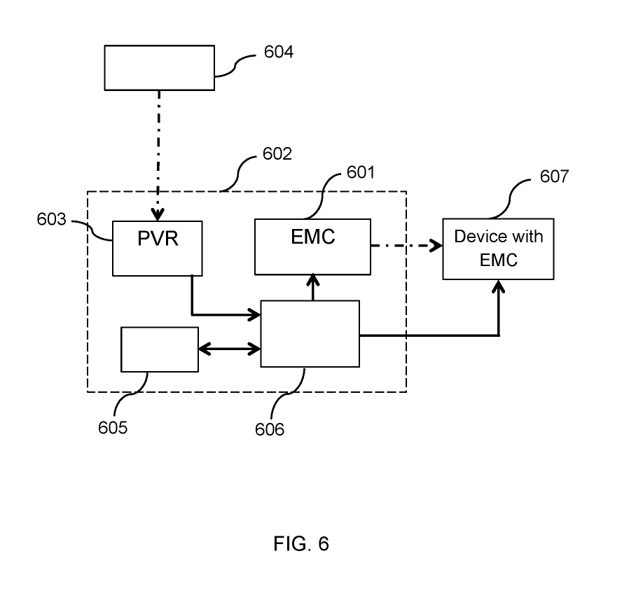

FIG. 6 is an exemplary embodiment of the wireless charging system adapted to charging devices equipped with an electromagnetic coil (EMC) 601, by first charging a device attachment 602 equipped with a PVR 603, and then using the EMC 601 to wirelessly charge a device by means of electromagnetic resonance. The arrows in the figure represent the direction of energy flow with the dot-dashed arrows representing wireless energy flow. The wireless- and wired charging of the device, respectively, is also presented by the dot-dashed- and solid arrow pointing to the device, respectively. The device attachment 602 comprising a PVR 603 receives optical energy from an energy source 604 comprising LEDs or LDs, or a combination thereof, and converts optical energy to electrical energy to charge a battery 605 through a charge controller 606. A device equipped with a EMC in resonance with the EMC 601 of the device attachment 602 can be charged wirelessly as shown by the dot-dashed arrow, or be charged using contacts or wires as shown by the solid arrow. A person with ordinary skills in the art can easily see that the same system is applicable to devices or device attachments equipped with other wireless charging mechanisms, such as inductive- or capacitive coupling, magnetic resonance, microwave, ultrasound, etc.

The composition of the LED and LD charging sources 406, 507, and 604 in FIGS. 4, 5, and 6, respectively, are only exemplary, and many other types of charging sources may be used to accomplish the charging process. For example, a hybrid charging lamp comprising both a LED source and a LD source can be used as the charging source 406, 507 or 604, respectively, to adapt to a variety of PVRs with different receiving spectra, or to increase the charging speed. In some configurations, one LD light source can be used for ranging to determine the position of a PVR, and a second LED- or LD light source can be used for energy delivery to an object to be charged. Or a first light source can be used for ranging initially, and then used in combination with a second light source for energy delivery. The light from both sources may be combined to give an output spectral distribution matching the spectral response of a PVR, and a LED light source can be used both for illumination and charging. A large variety of charging sources or a combinations of different light sources, including tungsten lamps, incandescent lamps, fluorescent lamps, infrared light sources, ultraviolet light sources, various laser sources, un-concentrated- or concentrated sunlight, filtered sunlight, and so forth, or a combination thereof, can be used in the wireless charging system of the present invention. When the light source comprises high power LDs, the wavelength of the LDs can be in the 1400-1800 nm spectrum region or other eye-safe spectrum region. For higher charging speeds, a plurality of charging sources can simultaneously charge a device, a device attachment, or a device case comprising at least one PVR. Conversely, a charging source can disperse its light energy to simultaneously charge a plurality of devices, device attachments, or device cases equipped with PVRs. All of these variations are within the scope of the present invention.

Although some of the above embodiment examples are described in detail using cell phone as the device and cell-phone case as the device attachment, it should be understood that the devices in the present invention can include any chargeable fixed- or mobile devices such as mobile phones, cameras, water meters, sensors, notebook computers, wireless speakers, IoT controllers, and so forth. The methods, apparatus and systems of the present invention are applicable to all of these devices.

While the methods, apparatus and systems described herein are presented in particular embodiments, it should be understood that these embodiments are for illustrations only, and that these embodiments do not limit the scope of the present invention. For example, the charging methods, apparatus and systems disclosed herein can include a variety of wired- and wireless embodiments based on different physical mechanisms, including solar charging, chemical charging, magnetic resonance charging, electromagnetic resonance charging, contact charging, thermal charging, optical charging, WiFi charging, ultrasonic charging, and so forth, or any combination of different wired- or wireless charging mechanisms. It is understood that modifications and variations to the embodiments described herein fall within the scope of the invention as defined in the following claims.

In the various embodiments of the adaptive charging apparatus and systems disclosed herein, the number- and composition of the components can vary depending on particular functionalities to be achieved. For example, a plurality of energy sources can be used to charge a single device case, or a plurality of device cases can be charged by a single energy source. An energy source can comprise a single lamp or LED, or a combination of a plurality of lamps, LDs and LEDs. An optical component assembly can comprise a single lens, or a combination of various optical components. It is understood that the above modifications and variations to the embodiments described herein fall within the scope of the invention as defined in the following claims.

What is claimed is:

1. A charging method comprising the steps of:
bestowing optical chargeability onto an electrically chargeable object by affixing an attachment comprising a photovoltaic receiver onto the object;
positioning the object with the attachment in a charging area;
generating light beams with substantial intensity within the charging area and with spectrum substantially matching the photovoltaic receiver spectrum;
delivering light-beam energy to the photovoltaic receiver of the object attachment;
charging the object with the attachment by converting light-beam energy to electrical energy using the photovoltaic receiver; and
terminating charging by dimming- or switching off the light beams or by removing the attachment from the charging area.

2. The method of claim 1, further comprising detaching a power module comprising at least one photovoltaic receiver and at least one battery from an object attachment, positioning- and charging the power module instead of charging the object with the attachment, and re-attaching the power module to the object attachment to charge the object.

3. The method of claims 1-2, further comprising steps of initiating a charging request, locating and tracking an object attachment or a detachable power module in real time, and adjusting- and delivering optical energy to the photovoltaic receiver of the attachment.

4. The method of claim 1, further comprising adjusting the intensity of the light beam to vary the charging speed, or to initiate or terminate charging.

5. A device case or attachment comprising:
a magnetic inner case or inner attachment including:
permanent magnets or magnetic materials, and
electrical contacts with one end connectable to a charging port of a device through electrical circuits; and
a power module attachable to the inner device case via magnetic force, including:
at least one power source,
electrical contacts positioned to match and engage the contacts of the inner case or attachment, and
magnets or magnetic materials positioned to attach the power module to the inner case using magnetic force.

6. The device case or attachment of claim 5, wherein the magnetic inner case or attachment further comprises a power source.

7. The device case or attachment of claims 5-6, wherein the power source comprises at least one photovoltaic receiver.

8. The device case or attachment of claims 5-6, wherein the power source comprises at least one energy-storage element such as a battery, a super capacitor, and so forth, or a combination of thereof.

9. The device case or attachment of claims 5-6, wherein the power source comprises at least one photovoltaic receiver and at least one energy-storage element.

10. The device case or attachment of claims 7 and 9, wherein the photovoltaic receiver comprises at least one solar cell or solar cell array.

11. The device case or attachment of claims 7 and 9-10, wherein the photovoltaic receiver comprises a plurality of optical- to electrical energy converters with different material compositions and spectral characteristics.

12. The device case or attachment of claims 7 and 9-11, wherein the photovoltaic receivers are foldable.

13. A wireless charging system comprising:
a device attachment or device case including:
at least one photovoltaic receiver, and
at least one energy storage element; and
a charging source including:
at least one light source having a substantial portion of its spectrum overlapping the spectral sensitivity range of the photovoltaic receiver, and
at least one optical component assembly.

14. The wireless charging system of claim 13, wherein the device attachment to be charged is magnetic inner case or the power module of claim 7.

15. The wireless charging system of claim 13, wherein the light source of the charging source comprises at least one light-emitting diode.

16. The wireless charging system of claim 13, wherein the light source of the charging source comprises at least one laser.

17. The wireless charging system of claim 13, wherein the light source is a hybrid light source comprising at least one light-emitting diode and at least one laser.

18. The wireless charging system of claims 13-17, wherein a portion of the energy of the light source is in the 1400-1800 nm wavelength region or other eye-safe wavelength regions.

19. The wireless charging system of claim 13-18, wherein a plurality of charging sources simultaneously charge a device attachment or a device case comprising at least one photovoltaic receiver.

20. The wireless charging system of claim 13-18, wherein a charging source simultaneously charges a plurality of device attachments or device cases.
